(19) United States
(12) Patent Application Publication
(10) Pub. No.: US 2003/0211200 A1
(43) Pub. Date: Nov. 13, 2003

(54) Method for enhancing carbohydrate utilization in ruminant animals

(76) Inventor: William H. Hoover, Morgantown, WV (US)

Correspondence Address: Paul M. Denk, 763 S. New Ballas Road, St. Louis, MO, 63141, US

(21) Appl. No.: 10/429,541

(22) Filed: May 2, 2003

Related U.S. Application Data
(60) Provisional application No. 60/378,227, filed on May 7, 2002.

(51) Int. Cl. A01K 1/00

(52) U.S. Cl. 426/2

(57) ABSTRACT

A feed additive for enhancing carbohydrate and protein utilization in ruminant animals, including processed sugars and sugar blends, liquid carrier, liquid carrier containing peptide and amino acid fermentation solubles, the sugars and liquid carrier blending with at least one fermentable complex carbohydrate, that mixture mixed with a solid carrier, forgoing combination being dried to a low moisture content less than thirty percent (30%) by weight of the mixture components, at a temperature not less than eighty degrees (80°) nor more than nine hundred degrees (900°) to provide the dried feed additive.

### BACKGROUND OF THE INVENTION

There are a variety of feed additives for ruminant animals, readily available upon the market, and which are designed to enhance the efficiency of the animal digesting the intake of feed, to maximize and increase the ruminal digestive efficiency of the animal, so as to attain increased nutritional effectiveness upon the animal, enhance feed intake, without any detrimental effects upon the animals digestive system. A variety of prior inventions have sought to attain such results, as can be seen in the prior patents to William Julien, U.S. Pat. No. 5,709,894, and U.S. Pat. No. 5,863,574. In those patents, a dried glutamic acid fermentation soluble was prepared for mixing with a carrier for addition to animal feed, to enhance the nutritional intake of the ruminant, during feed intake.

### SUMMARY OF THE INVENTION

This invention generally relates to a feed additive for ruminant animals. The feed additive, when used as a component in a diet formulated for this class of animals, being the ruminant type animals, the ingestion of the invention by the feed animal will increase ruminal digestive efficiency, even perhaps enhance feed intake, but generally attain greater efficiency in animal growth and weight additiveness at lesser cost. This is critical to the successful economics of farming.

Generally, the invention utilizes a composition of sugars that are hydrated or blended into a liquid carrier, with this composition then intermixed with a dry carrier such as wheat middlings, and then dried. This type of composition can then be fed directly to the animal, or mixed with its standard dry feed intake, to attain its effective results.

### DESCRIPTION OF THE PREFERRED EMBODIMENT

This invention enhances the efficiency obtained from the feeding of ruminant animals, and relates to a feed additive for such animals, to provide for enhanced weight gain, from the same amount of feed normally fed to such animals. When utilized as a component in a diet formulated for this class of animal, the inventive feed additive will increase ruminal digestive efficiency. In the preferred embodiment of the invention, simple sugars, such as glucose, sucrose, fructose, or lactose, are hydrated or blended into a liquid carrier. The liquid carrier may include molasses, corn steep liquor, or other fermentation end products, such as corn fermentation solubles or glutamic acid fermentation solubles. These materials may then be blended into a carrier, such as wheat middlings, soybean meal, corn feed, or any of the other dry feed compositions readily available and used for feeding ruminant animals. The blended materials are then dried, at temperatures that will generally not denature the organic components of the mix. In addition, the total moisture content of the dried blended materials will preferably be a moisture content of less that thirty percent (30%) by weight of the said component mixture. The temperature used may vary, with the drying method employed, but generally temperatures ranging between eighty degrees (80°) to not more than nine hundred degrees (900°) Fahrenheit.

An example of a composition of carbohydrate formulated in this manner may be seen from the following chart.

### FIRST EXAMPLE

| Component | Range Percent by Weight |
|---|---|
| Sugars | 8% to 18% |
| Liquid carrier, Molasses, etc. | 10% to 25% |
| Carrier, Wheat Middlings, etc. | 78% to 60% |

### SECOND EXAMPLE

| Component | Range Percent by Weight |
|---|---|
| Processed sugars and sugar polymers | 15% to 25% |
| Liquid Fermentation end-products | 30% to 50% |
| Carrier, Wheat Middlings, etc. | 40% to 50% |

This type of composition, prepared in the manner described, and within the ranges of ingredients, is effective in the productivity of ruminants, particularly the lactating cows. The results attained are largely dependent on the ability of the diet to maximize the growth of the rumin microbes. Since these microbes rely mainly on ready fermentation carbohydrates for growth, it is long been thought that sugars should be an excellent source of such nutrients. Thus, it is believed that sugars may be a valuable amendment to the diet of producing cattle. But, to the contrary, responses to feeding sugars to ruminants has been somewhat disappointing, in the past. This application reveals that sugars, being water soluble, flow from the rumin with the liquid portion of the rumin contents at a rate that exceeds the rate of fermentation by the rumin microbes. In order to maximize the value of the sugars to the ruminants, the intent is to process the sugars in a way that converts the sugars to a less soluble, particulate form that will be retained by the rumin until fermented, and thus, at that stage, enhances microbial growth. This increases the efficiency of the ruminant system to attain more efficient growth, from the dry feed being processed, during raising and growing of the ruminant animal.

Variations or modification to the subject matter of this invention may occur to those skilled in the art upon review of the summary as provided herein. Such variations, if within the spirit of this development, are intended to be encompassed within the scope of the invention as defined. The description of the preferred embodiment is set forth for illustrative purposes only.

1. A feed additive for enhancing carbohydrate and protein utilization in ruminant animals, and increase the ruminal digestive deficiency and feed intake, comprising, in combination, processed sugars and sugar blends, a liquid carrier, sugars being blended into said liquid carrier, said liquid carrier containing the peptide and amino acid fermentation solubles, sugars and liquid carrier blending with at least one fermentable complex carbohydrate, that mixture mixed with a solid carrier, foregoing combination being dried to a low moisture content at a temperature of not less than eighty degrees (80° F.) and not more than nine hundred degrees (900° F.) to provide a dry feed additive.

2. The feed additive of claim 1 wherein the various components of the mixture having a range percent by weight as follows:

| Component | Range Percent by Weight |
|---|---|
| Sugars | 8% to 18% |
| Liquid carrier, Molasses, etc. | 10% to 25% |
| Carrier, Wheat Middlings, etc. | 78% to 60% |

wherein said additive enhances ruminal digestive efficiency

3. The feed additive of claim 2 wherein the processed sugars and sugar blends includes at least one of glucose, sucrose, fructose and lactose.

4. The feed additive of claim 2 wherein the liquid carrier may include at least one of molasses, corn steep liquor, other fermentation in-products such as corn fermentation solubles.

5. The feed additive of claim 2 wherein the solid carrier includes fully fermentable complex carbohydrates, including at least one of soybean halls, heat processed grains, beet or citrus pulp, and other bi-products.

6. The feed additive of claim 5 and including said mixture being blended to a carrier such as wheat middlings.

7. The feed additive of claim 1 wherein the various components of the mixture having a range percent by weight as follows:

| Component | Range Percent by Weight |
|---|---|
| Processed sugars and sugar polymers | 15% to 25% |
| Liquid Fermentation end-products | 30% to 50% |
| Carrier, Wheat Middlings, etc. | 40% to 50% |

wherein said additive enhances ruminal digestive efficiency.
